(19) United States
(12) Patent Application Publication
(10) Pub. No.: US 2023/0016425 A1
(43) Pub. Date: Jan. 19, 2023

(54) Sound Signal Generation Method, Estimation Model Training Method, and Sound Signal Generation System

(71) Applicant: Yamaha Corporation, Hamamatsu-shi (JP)

(72) Inventors: Masanari NISHIMURA, Hamamatsu-shi (JP); Keijiro SAINO, Hamamatsu-shi (JP)

(21) Appl. No.: 17/951,298

(22) Filed: Sep. 23, 2022

Related U.S. Application Data
(63) Continuation of application No. PCT/JP2021/009031, filed on Mar. 8, 2021.

(30) Foreign Application Priority Data
Mar. 25, 2020 (JP) 2020-054465

(51) Int. Cl. G10H 1/00; G06N 3/08

(52) U.S. Cl. CPC G10H 1/0008; G06N 3/08; G10H 2210/066; G10H 2210/095; G10H 2250/311; G10H 2210/051

(57) ABSTRACT

A method generates a sound signal in accordance with score data representative of respective durations of a plurality of notes and a shortening indication to shorten a duration of a specific note. The method includes generating a shortening rate, generating a series of control data, and generating a sound signal. The shortening rate is representative of an amount of shortening of the duration of the specific note, and is generated, by inputting, to a first estimation model, condition data representative of a sounding condition specified by score data for the specific note. Each of the series of control data is representative of a control condition of the sound signal corresponding to the score data, and the series of control data reflects a shortened duration of the specific note shortened in accordance with the generated shortening rate. The sound signal is generated in accordance with the series of control data.

This application is a Continuation application of PCT Application No. PCT/JP2021/009031, filed on Mar. 8, 2021, and is based on and claims priority from Japanese Patent Application No. 2020-054465, filed on Mar. 25, 2020, the entire contents of each of which are incorporated herein by reference.

### BACKGROUND

The present disclosure relates to techniques for generating sound signals. There have been proposed technologies for generating sound signals that represent various types of sounds, such as singing or instrumental sounds. For example, a known Musical Instrument Digital Interface (MIDI) sound source generates sound signals for sounds to which musical symbols such as staccato are assigned. “A NEURAL PARAMETRIC SINGING SYNTHESIZER,” (Merlijn Blaauw and Jordi Bonada, arXiv, Apr. 12, 2017) (hereafter, Blaauw et al.) discloses a technology for synthesizing singing sounds using a neural network.

In conventional MIDI sound sources, a duration of a note indicated as staccato is shortened by a predetermined fixed rate (e.g., 50%) by controlling a gate time. However, an amount by which a duration of a note indicated as staccato is shortened in actual singing or instrumental playing of a piece of music varies dependent on a variety of factors, such as pitches of notes that occur before and after the note indicated as staccato. Consequently, it is not easy to generate a sound signal that represents a natural musical sound using a conventional MIDI sound source that shortens by a fixed amount a duration of a note indicated as staccato.

In the technology of Blaauw et al., staccato is not indicated individually for each of a note, although a duration of an individual note may be shortened as a result of tendencies arising in training data used for machine learning. In the above explanation, staccato is referred to as an example of an indication for shortening a duration of a note. However, the same problem occurs in applying other indications used for shortening a duration of a note.

### SUMMARY

Given the above circumstances, an object of one aspect of the present disclosure is to generate a sound signal representative of a natural musical sound from score data that includes an indication to shorten a duration of a note.

In order to solve the above problem, a method of generating sound signals according to one aspect of the present disclosure is a method of generating a sound signal in accordance with score data representative of respective durations of a plurality of notes and a shortening indication to shorten a duration of a specific note from among the plurality of notes. In this method, a shortening rate representative of an amount of shortening of the duration of the specific note is generated, by inputting, to a first estimation model, condition data representative of a sounding condition specified by the score data for the specific note. A series of control data, each representing a control condition of the sound signal corresponding to the score data is generated, the series of control data reflecting a shortened duration of the specific note shortened in accordance with the generated shortening rate; and the sound signal is generated in accordance with the series of control data.

In a method of training an estimation model according to one aspect of the present disclosure, a plurality of training data is obtained, each including condition data and a corresponding shortening rate, the condition data representing a sounding condition specified for a specific note by score data representing: respective durations of a plurality of notes, and a shortening indication for shortening a duration of the specific note, which is one of the plurality of notes, and the shortening rate representing an amount of shortening of the duration of the specific note; and an estimation model is trained to learn a relationship between the condition data and the shortening rate by machine learning using the plurality of training data.

A sound signal generation system according to one aspect of the present disclosure is a system for generating a sound signal depending on score data representative of respective durations of a plurality of notes and a shortening indication to shorten a duration of a specific note from among the plurality of notes. The system includes: one or more memories for storing instructions; and one or more processors communicatively connected to the one or more memories. The one or more processors execute instructions to generate a shortening rate representative of an amount of shortening of the duration of the specific note, by inputting, to a first estimation model, condition data representative of a sounding condition specified by the score data for the specific note; generate a series of control data, each representing a control condition of the sound signal corresponding to the score data, the series of control data reflecting a shortened duration of the specific note shortened in accordance with the generated shortening rate; and generate the sound signal in accordance with the series of control data.

### BRIEF DESCRIPTION OF THE DRAWINGS

FIG. 1 is a block diagram illustrating a configuration of a sound signal generation system;

FIG. 2 is an explanatory diagram showing data used by a signal generator;

FIG. 3 is a block diagram illustrating a functional configuration of the sound signal generation system;

FIG. 4 is a flowchart illustrating example procedures for signal generation processing;

FIG. 5 is an explanatory diagram showing data used by a learning processor;

FIG. 6 is a flowchart illustrating example procedures for learning processing by a first estimation model;

FIG. 7 is a flowchart illustrating example procedures for processing for acquiring training data;

FIG. 8 is a flowchart illustrating example procedures for machine learning processing;

FIG. 9 is a block diagram illustrating a configuration of a sound signal generation system; and

FIG. 10 is a flowchart illustrating example procedures for signal generation processing.

### DETAILED DESCRIPTION

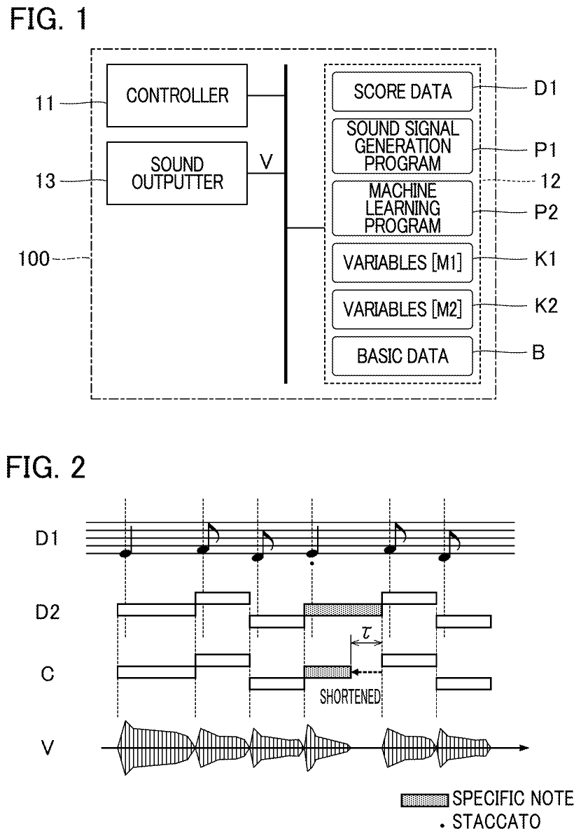

FIG. 1 is a block diagram illustrating a configuration of a sound signal generation system 100 according to an embodiment of the present disclosure. The sound signal generation system 100 is a computer system provided with a controller 11, a storage device 12, and a sound outputter 13. The sound signal generation system 100 is realized by an information terminal, such as a smartphone, tablet terminal, or personal computer. The sound signal generation system 100 can be realized by use either of a single device or by use of multiple devices (e.g., a client-server system) configured separately from each other.

The controller 11 is constituted of either a single processor or multiple processors that control each element of the sound signal generation system 100. Specifically, the controller 11 is constituted of one or more types of processors, such as a Central Processing Unit (CPU), a Sound Processing Unit (SPU), a Digital Signal Processor (DSP), a Field Programmable Gate Array (FPGA), an Application Specific Integrated Circuit (ASIC), or any similar type of processor.

The controller 11 generates a sound signal V representative of a sound, which is a target for synthesis (hereafter, “target sound”). The sound signal V is a time-domain signal representative of a waveform of a target sound. The target sound is a music performance sound produced by playing a piece of music. Specifically, the target sound includes not only a music performance sound produced by playing a musical instrument but also produced by singing. The term “music performance” as used here means performing music not only by playing a musical instrument but also by singing.

The sound outputter 13 outputs a target sound represented by the sound signal V generated by the controller 11. The sound outputter 13 is, for example, a speaker or headphones. For convenience of explanation, a D/A converter that converts the sound signal V from digital to analog format, and an amplifier that amplifies the sound signal V are not shown in the drawings. FIG. 1 shows an example of a configuration in which the sound outputter 13 is mounted to the sound signal generation system 100. However, the sound outputter 13 may be provided separately from the sound signal generation system 100 and connected thereto either by wire or wirelessly.

The storage device 12 comprises either a single memory or multiple memories that store programs executable by the controller 11, and a variety of data used by the controller 11. The storage device 12 is constituted of a known storage medium, such as a magnetic or semiconductor storage medium, or a combination of several types of storage media. The storage device 12 may be provided separate from the sound signal generation system 100 (e.g., cloud storage), and the controller 11 may perform writing to and reading from the storage device 12 via a communication network, such as a mobile communication network or the Internet. In other words, the storage device 12 need not be included in the sound signal generation system 100.

The storage device 12 stores score data D1 representative of a piece of music. As shown in FIG. 2, the score data D1 specifies pitches and durations (note values) of notes that constitute the piece of music. When the target sound is a singing sound, the score data D1 also specifies phonetic identifiers (lyrics) for notes. Staccato is indicated for one or more of the notes specified by the score data D1 (hereafter, “specific note”). Staccato indicated by a musical symbol above or below a note signifies that a duration of the note be shortened. The sound signal generation system 100 generates the sound signal V in accordance with the score data D1.

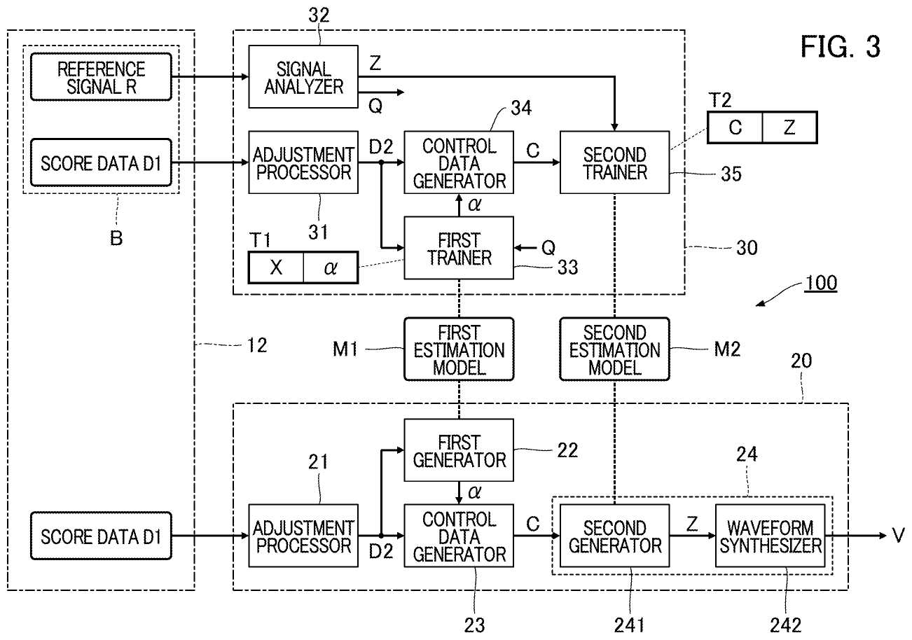

FIG. 3 is a block diagram illustrating a functional configuration of the sound signal generation system 100. The controller 11 executes a sound signal generation program P1 stored in the storage device 12 to function as a signal generator 20. The signal generator 20 generates sound signals V from the score data D1. The signal generator 20 has an adjustment processor 21, a first generator 22, a control data generator 23, and an output processor 24.

The adjustment processor 21 generates score data D2 by adjusting the score data D1. Specifically, as shown in FIG. 2, the adjustment processor 21 generates the score data D2 by adjusting start and end points specified by the score data D1 for each note along a timeline. Thus, a performance sound of a piece of music may start to be produced before arrival of a start point of a note specified by the score. For example, when a lyric consisting of a combination of a consonant and a vowel is to be sounded, a singing sound is perceived by a listener as a natural sound if the consonant starts to be sounded before the start point of the note and thereafter the vowel starts to be sounded at the start point. Taking this tendency into account, the adjustment processor 21 generates the score data D2 by adjusting start and end points of each note represented by the score data D1 backward (at earlier points) along the timeline. For example, by adjusting backward a start point of each note specified by the score data D1, the adjustment processor 21 adjusts a duration of each note so that sounding of a consonant starts prior to a start point of the note before adjustment, and sounding of a vowel starts at the start point. Similarly to the score data D1, the score data D2 specifies respective pitches and durations of notes in a piece of music, and includes staccato indications (shortening indications) for specific notes.

The first generator 22 in FIG. 3 generates a shortening rate α, which represents an amount of shortening of the duration of a specific note from among a plurality of notes specified by the score data D2. A shortening rate α is generated for each of a specific note in the piece. To generate a shortening rate a, the first generator 22 uses a first estimation model M1. The first estimation model M1 is a statistical model that outputs a shortening rate α in response to input of condition data X representative of a condition specified by the score data D2 for a specific note (hereafter “sounding condition”). In other words, the first estimation model M1 is a machine learning model that learns a relationship between a sounding condition of a specific note in a piece of music and a shortening rate a for the specific note. The shortening rate α is, for example, an amount of reduction due to shortening relative to a full duration of the specific note before being shortened, and is set to a positive number less than 1. Of the full duration of the specific note before shortening, the amount of reduction corresponds to a time length of a section that is lost due to the shortening (i.e., a difference between the duration before and after shortening).

The sounding condition (context) represented by the condition data X includes, for example, a pitch and a duration of a specific note. The duration may be specified by a time length or by a note value. The sounding condition also includes, for example, information on at least one of a note before (e.g., just before) the specific note or a note after (e.g., just after) the specific note, such as a pitch, duration, start point, end point, pitch difference from the specific note, etc. However, information on the note before or after the specific note may be omitted from the sounding condition represented by the condition data X.

The first estimation model M1 is constituted, for example, of a recurrent neural network (RNN), or a convolutional neural network (CNN), or any other form of deep neural network. A combination of multiple types of deep neural networks may be used as the first estimation model M1. Additional elements, such as a long short-term memory (LSTM) unit, may also be included in the first estimation model M1.

The first estimation model M1 is realized by a combination of an estimation program that causes the controller 11 to perform an operation to generate a shortening rate a from condition data X, and multiple variables K1 (specifically, weighted values and biases) applied to the operation. The variables K1 of the first estimation model M1 are established in advance by machine learning and stored in the storage device 12.

The control data generator 23 generates control data C in accordance with the score data D2 and the shortening rate α. Generation of the control data C by the control data generator 23 is performed for each unit period (e.g., a frame of a predetermined length) along the timeline. A time length of each unit period is sufficiently short relative to a respective note in a piece of music.

The control data C represents a sounding condition (an example of a “control condition”) of a target sound corresponding to the score data D2. Specifically, the control data C for each unit period includes, for example, a pitch N and a duration of a note including the unit period. Further, the control data C for each unit period includes, for example, information on at least one of a note before (e.g., just before) or a note after (e.g., just after) the note including the unit period, such as a pitch, duration, start point, end point, pitch difference from the specific note, etc. When the target sound is a singing sound, the control data C includes phonetic identifiers (lyrics). The information on the preceding or subsequent notes may be omitted from the control data C.

FIG. 2 schematically illustrates pitches of a target sound expressed by a series of the control data C. The control data generator 23 generates control data C, which represents a sounding condition that reflects shortening of a duration of a specific note by the shortening rate α. The specific note represented by the control data C is a note specified by the score data D2 that has been shortened in accordance with the shortening rate α. For example, the duration of the specific note represented by the control data C is set to a time length obtained by multiplying the full duration of the specific note specified by the score data D2, by a value obtained by subtracting the shortening rate α from a predetermined value (e.g., 1). The start point of the specific note represented by the control data C and the start point of the specific note represented by the score data D2 are the same. Therefore, as a result of the shortening of the specific note, a period of silence (hereafter, “silent period”) T occurs from an end point of the specific note to a start point of a note just after the specific note. For each unit period within the silent period T, the control data generator 23 generates control data C indicative of silence. For example, control data C, in which the pitch N is set to a numerical value signifying silence, is generated for each unit period within the silent period T. Instead of generating the control data C in which the pitch N is set to silence, control data C representative of rests may be generated by the control data generator 23 for each unit period within the silent period T. In other words, it is only necessary that the control data C be data for enabling distinction between a sounding period in which notes are sounded and a silent period T in which notes are not sounded.

The output processor 24 in FIG. 3 generates a sound signal V in accordance with a series of the control data C. In other words, the control data generator 23 and the output processor 24 function as elements that generate a sound signal V in which a specific note has been shortened in accordance with a shortening rate a. The output processor 24 has a second generator 241 and a waveform synthesizer 242.

The second generator 241 generates frequency characteristics Z of a target sound using the control data C. A frequency characteristic Z shows a characteristic amount of the target sound in the frequency domain. Specifically, the frequency characteristic Z includes a frequency spectrum, such as a mel-spectrum or an amplitude spectrum, and a fundamental frequency of the target sound. The frequency characteristic Z is generated for each unit period. Specifically, the frequency characteristic Z for each unit period is generated from control data C for the unit period. In other words, the second generator 241 generates a series of the frequency characteristics Z.

A second estimation model M2 separate from the first estimation model M1 is used by the second generator 241 to generate a frequency characteristic Z. The second estimation model M2 is a statistical model that outputs a frequency characteristic Z in response to input of control data C. In other words, the second estimation model M2 is a machine learning model that learns a relationship between control data C and a frequency characteristic Z.

The second estimation model M2 is constituted of any form of deep neural network, such as, for example, a recurrent neural network or a convolutional neural network. A combination of multiple types of deep neural networks may be used as the second estimation model M2. An additional element such as a LSTM unit may also be included in the second estimation model M2.

The second estimation model M2 is realized by a combination of an estimation program that causes the controller 11 to perform an operation to generate a frequency characteristic Z from control data C, and multiple variables K2 (specifically, weighted values and biases) applied to the operation. The variables K2 of the second estimation model M2 are established in advance by machine learning and are stored in the storage device 12.

The waveform synthesizer 242 generates a sound signal V of a target sound from a series of the frequency characteristics Z. The waveform synthesizer 242 transforms the frequency characteristics Z into a time-domain waveform by operations including, for example, a discrete inverse Fourier transform, and generates the sound signal V by concatenating the waveforms for consecutive unit periods. For example, by using a deep neural network (so-called, neural vocoder) that has learned a relationship between a frequency characteristic Z and a sound signal V, the waveform synthesizer 242 can generate the sound signal V from the frequency characteristics Z. The sound signal V generated by the waveform synthesizer 242 is supplied to the sound outputter 13, and the target sound is output from the sound outputter 13.

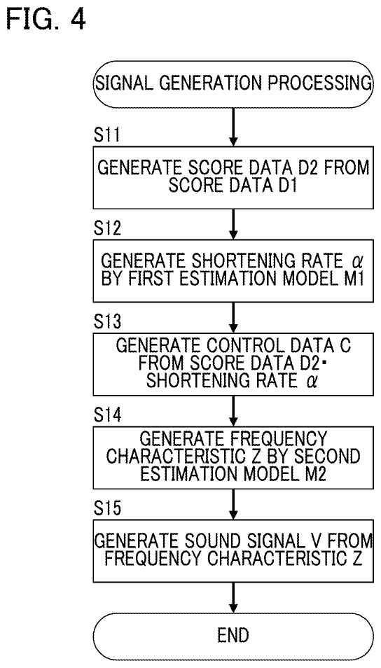

FIG. 4 is a flowchart illustrating example procedures for processing by which the controller 11 generates sound signals V (hereafter, “signal generation processing”). The signal generation processing is initiated by an instruction from the user, for example.

When the signal generation processing is started, the adjustment processor 21 generates score data D2 from score data D1 stored in the storage device 12 (S11). The first generator 22 detects a specific note for which staccato is indicated from among a plurality of notes represented by the score data D2, and generates a shortening rate α by inputting condition data X for the specific note into the first estimation model M1 (S12).

The control data generator 23 generates control data C for each unit period in accordance with the score data D2 and the generated shortening rate a (S13). As described above, the shortening of a specific note in accordance with the shortening rate α is reflected in the generated control data C. The control data C represents silence for a unit period that is within the resulting silent period τ.

The second generator 241 inputs the generated control data C into the second estimation model M2 to generate a frequency characteristic Z for each unit period (S14). The waveform synthesizer 242 generates from the generated frequency characteristic Z of the unit period a sound signal V of the target sound of a portion that corresponds to the unit period (S15). The generation of the control data C (S13), the generation of the frequency characteristic Z (S14), and the generation of the sound signal V (S15) are performed for each unit period, for the entire piece of music. In other words, in the processing from Steps S13 to S15, control data C is generated that represents a sounding condition based on the score data D2 and the shortening rate a, and in accordance with the control data C, a sound signal is generated in which the duration of the specific note is shorted by the shortening rate α.

As described above, in the embodiment, a shortening rate α is generated by inputting into the first estimation model M1 the condition data X of a specific note from among the plurality of notes represented by the score data D2, and control data C is generated in which there is reflected the shortening of the duration of the specific note in accordance with the generated shortening rate α. Thus, the amount by which a specific note is shortened changes dependent on a sounding condition of the specific note in a piece of music. As a result, a natural music sound signal V of the target sound can be generated from the score data D2 including a staccato for the specific note.

As shown in FIG. 3, the controller 11 executes a machine learning program P2 stored in the storage device 12, to function as a learning processor 30. The learning processor 30 trains by machine learning the first estimation model M1 and the second estimation model M2 used in the signal generation processing. The learning processor 30 has an adjustment processor 31, a signal analyzer 32, a first trainer 33, a control data generator 34, and a second trainer 35.

The storage device 12 stores a plurality of basic data B used for machine learning. Each of the plurality of basic data B comprises a combination of score data D1 and a reference signal R. As described above, the score data D1 specifies respective pitches and durations of a plurality of notes of a piece of music, and includes staccato indications (shortened note indications) for specific notes. A plurality of basic data B for different pieces of music, each basic data B including score data D1, is stored in the storage device 12.

The adjustment processor 31 of the learning processor 30 in FIG. 3 generates score data D2 from score data D1 of each basic data B in the same way as the adjustment processor 21 of the signal generator 20 generates the score data D2, which is described above. As in the score data D1, the score data D2 specifies pitches and durations of notes of a piece of music, and includes staccato indications (shortening indications) for specific notes. However, a duration of a specific note specified by the score data D2 is not shortened. In other words, staccato is not reflected in the score data D2.

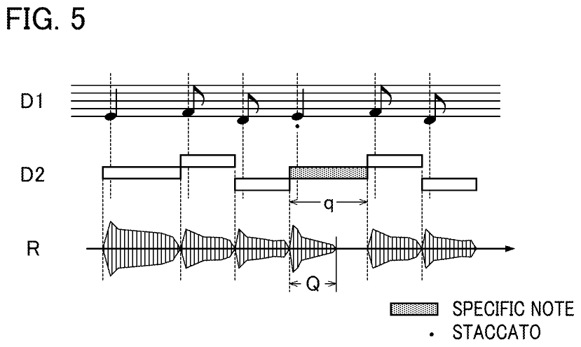

FIG. 5 is an explanatory diagram showing data used by the learning processor 30. The reference signal R included in each basic data B is a time-domain signal representing a performance sound of a piece of music corresponding to the score data D1 in the same basic data B. For example, the reference signal R is generated by recording a musical sound produced by a musical instrument when a piece of music is played or a singing sound produced when a piece of music is sung.

The signal analyzer 32 of the learning processor 30 in FIG. 3 identifies, in the reference signal R, a sounding period Q of a musical performance sound corresponding to the respective note. As shown in FIG. 5, for example, a point in the reference signal R at which the pitch or the phonetic identifier changes or the volume falls below a threshold value, is identified as the start point or end point of the respective sounding period Q. The signal analyzer 32 also generates a frequency characteristic Z of the reference signal R for each unit period along the timeline. The frequency characteristic Z is a characteristic amount in the frequency domain, and the characteristic amount includes a frequency spectrum, such as a mel-spectrum or an amplitude spectrum, for example, and a fundamental frequency of the reference signal R, as described above.

The sounding period Q of a sound corresponding to the respective note in the piece of music in the reference signal R generally corresponds to a sounding period q of the respective note represented by the score data D2. However, since staccato is not reflected in each sounding period q represented by the score data D2, the sounding period Q corresponding to a specific note in the reference signal R is shorter than the sounding period q of the specific note represented by the score data D2. As will be understood from the above explanation, it is possible to identify an amount by which the duration of the specific note in the piece is shortened in actual performance by comparing the sounding period Q and the sounding period q of the specific note.

The first trainer 33 in FIG. 3 trains the first estimation model M1 by learning processing Sc using a plurality of training data T1. The learning processing Sc is supervised machine learning using training data T1. Each of the plurality of training data T1 comprises a combination of condition data X and a shortening rate α (ground truth).

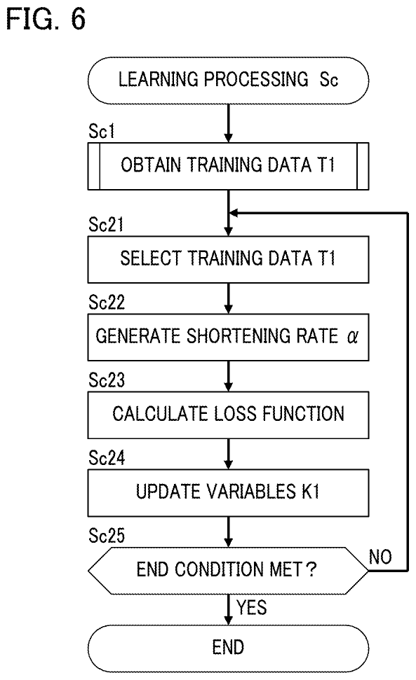

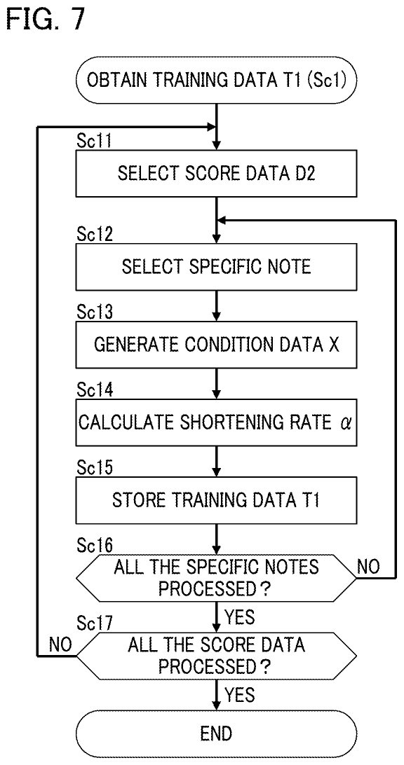

FIG. 6 is a flowchart illustrating example procedures for the learning processing Sc. When the learning processing Sc is started, the first trainer 33 obtains a plurality of training data T1 (Sc1). FIG. 7 is a flowchart illustrating example procedures for the processing Sc1 by which the first trainer 33 obtains the training data T1.

The first trainer 33 selects one of a plurality of score data D2 (hereafter, “selected score data D2”) (Sc11), where the score data D2 has been generated by the adjustment processor 31 from a plurality of differing score data D1. The first trainer 33 selects a specific note (hereafter, “selected specific note”) from a plurality of notes represented by the selected score data D2 (Sc12). The first trainer 33 generates condition data X representing a sounding condition of the selected specific note (Sc13). The sounding condition (context) represented by the condition data X includes a pitch and a duration of the selected specific note, a pitch and a duration of a note before (e.g., just before) the selected specific note, and a pitch and a duration of the note after (e.g., just after) the selected specific note, as described above. The difference in pitch between the selected specific note and the note just before or just after the selected specific note may be included in the sounding condition.

The first trainer 33 calculates a shortening rate α of the selected specific note (Sc14). Specifically, the first trainer 33 generates the shortening rate α by comparing the sounding period q of the selected specific note represented by the selected score data D2 and the sounding period Q of the selected specific note identified by the signal analyzer 32 from the reference signal R. For example, the time length of the sounding period Q relative to the time length of the sounding period q is calculated as the shortening rate α. The first trainer 33 stores training data T1, which comprises a combination of the condition data X of the selected specific note and the shortening rate α of the selected specific note, in the storage device 12 (Sc15). A shortening rate α in each training data T1 corresponds to a ground truth, i.e., a shortening rate α for generation by the first estimation model M1 based on the condition data X in the same training data T1.

The first trainer 33 determines whether training data T1 has been generated for all of the specific notes in the selected score data D2 (Sc16). If there are any unselected specific notes (Sc16: NO), the first trainer 33 selects an unselected specific note from the plurality of specific notes represented by the selected score data D2 (Sc12) and generates training data T1 for the selected specific note (Sc13-Sc15).

After generating training data T1 for all the specific notes in the selected score data D2 (Sc16: YES), the first trainer 33 determines whether the above processing has been executed for all of the score data D2 (Sc17). If there is any unselected score data D2 (Sc17: NO), the first trainer 33 selects the unselected score data D2 from the score data D2 (Sc11), and generates training data T1 for the specific notes for the selected score data D2 (Sc12-Sc16). When the generation of training data T1 has been executed for all of the score data D2 (Sc17: YES), a plurality of training data T1 is stored in the storage device 12.

After generating the plurality of training data T1 by the above procedures, the first trainer 33 trains the first estimation model M1 by machine learning using the plurality of training data T1, as shown in FIG. 6 (Sc21-Sc25). First, the first trainer 33 selects one of the plurality of training data T1 (hereafter, “selected training data T1”) (Sc21).

The first trainer 33 inputs the condition data X in the selected training data T1 into a tentative first estimation model M1 to generate α shortening rate α (Sc22). The first trainer 33 calculates a loss function that represents an error between the shortening rate α generated by the first estimation model M1 and the shortening rate α in the selected training data T1 (i.e., the ground truth) (Sc23). The first trainer 33 updates the variables K1 that define the first estimation model M1 so that the loss function is reduced (ideally minimized) (Sc24).

The first trainer 33 determines whether a predetermined end condition is met (Sc25). The end condition is, for example, a condition that the loss function is below a predetermined threshold, or an amount of change in the loss function is below a predetermined threshold. If the end condition is not met (Sc25: NO), the first trainer 33 selects unselected training data T1 (Sc21), and the thus selected training data T1 is used to calculate a shortening rate α (Sc22), a loss function (Sc23), and to update the variables K1 (Sc24).

The variables K1 of the first estimation model M1 are set as the numerical values when the end condition is met (Sc25: YES). As described above, by using the training data T1 the variables K1 are updated (Sc24) repeatedly until the end condition is met. Thus, the first estimation model M1 learns a potential relationship between the condition data X and the shortening rates a in the plurality of training data T1. In other words, the first estimation model M1 after training by the first trainer 33 outputs a statistically valid shortening rate α under the relationship in response to input of unknown condition data X.

Similarly to the control data generator 23 of the signal generator 20, the control data generator 34 of the learning processor 30 in FIG. 3 generates control data C in accordance with the score data D2 and a shortening rate α for each unit period. To generate the control data C, a shortening rate α calculated by the first trainer 33 at step Sc22 of the learning processing Sc, or a shortening rate α generated using the first estimation model M1 which has gone through the learning processing Sc is used. A plurality of training data T2 is supplied to the second trainer 35, each of the plurality of training data T2 comprising a combination of the control data C generated for a respective unit period by the control data generator 34 and the corresponding frequency characteristic Z generated for that unit period by the signal analyzer 32 from the reference signal R.

The second trainer 35 trains the second estimation model M2 by learning processing Se using the plurality of training data T2. The learning processing Se is supervised machine learning that uses the plurality of training data T2. Specifically, the second trainer 35 calculates an error function representing an error between (i) a frequency characteristic Z output by a tentative second estimation model M2 in response to input of control data C in each of the plurality of training data T2, and (ii) a frequency characteristic Z included in the same training data T2. The second trainer 35 repeatedly updates the variables K2 that define the second estimation model M2 so that the error function is reduced (ideally minimized). Thus, the second estimation model M2 learns a potential relationship between control data C and frequency characteristics Z in the plurality of training data T2. In other words, the second estimation model M2 after training by the second trainer 35 outputs a statistically valid frequency characteristic Z for unknown control data C.

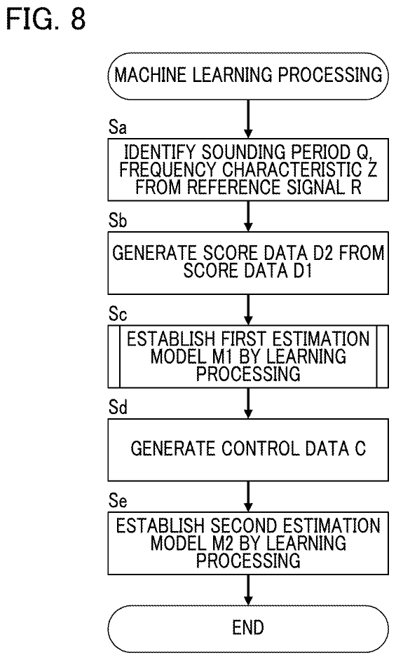

FIG. 8 shows a flowchart illustrating example procedures for processing by which the controller 11 trains the first estimation model M1 and the second estimation model M2 (hereafter, “machine learning processing”). The machine learning processing is initiated by an instruction from the user, for example.

When the machine learning processing is started, the signal analyzer 32 identifies, from the reference signal R in each of the plurality of basic data B, a plurality of sounding periods Q and a frequency characteristic Z for each unit period (Sa). The adjustment processor 31 generates score data D2 from score data D1 in each of the plurality of basic data B (Sb). The order of the analysis of the reference signal R (Sa) and the generation of the score data D2 (Sb) may be reversed.

The first trainer 33 trains the first estimation model M1 by the above described learning processing Sc. The control data generator 34 generates control data C for each unit period in accordance with the score data D2 and the shortening rate α (Sd). The second trainer 35 trains the second estimation model M2 by the learning processing Se using a plurality of training data T2 each including control data C and a frequency characteristic Z.

As will be understood from the above explanation, the first estimation model M1 is trained to learn a relationship between (i) condition data X, which represents the condition of a specific note from among the plurality of notes represented by the score data D2, and (ii) a shortening rate α, which represents an amount of shortening of the duration of the specific note. Thus, the shortening rate α of the duration of a specific note is changed depending on the sounding condition of the specific note. Therefore, a natural music sound signal V of the target sound can be generated from score data D2 including staccato that shortens a duration of a note.

Another embodiment will now be described. For elements whose functions are similar to those of the previous embodiment in each of the following embodiments and modifications, the reference signs used in the description of the previous embodiment are used and detailed descriptions of such elements are omitted as appropriate.

In the previous embodiment, the shortening rate α is applied to the processing (Sd) in which the control data generator 23 generates control data C from score data D2. In the present embodiment, the shortening rate α is applied to the processing in which the adjustment processor 21 generates score data D2 from score data D1. The configuration of the learning processor 30 and the details of the machine learning processing are the same as those in the previous embodiment.

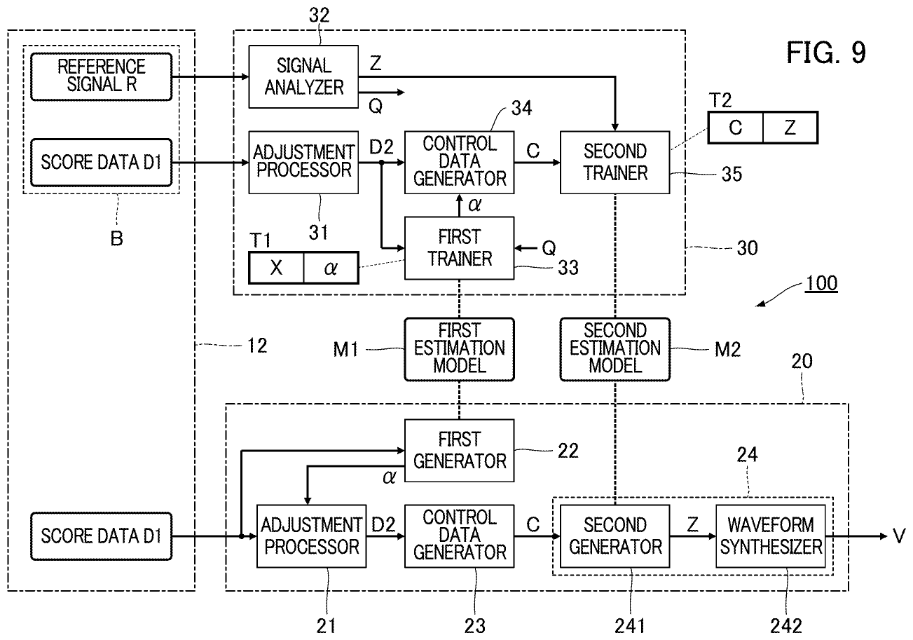

FIG. 9 is a block diagram illustrating a functional configuration of a sound signal generation system 100 according to the present embodiment. The first generator 22 generates a shortening rate α, which represents an amount of shortening of the duration of a specific note from among a plurality of notes specified by the score data D1, for a specific note within a piece of music represented by the score data D1. Specifically, the first generator 22 generates a shortening rate α for the specific note by inputting condition data X to the first estimation model M1, the condition data X representing a sounding condition that the score data D1 specifies for the specific note.

The adjustment processor 21 generates score data D2 by adjusting the score data D1. A shortening rate α is applied to the generation of score data D2 by the adjustment processor 21. Specifically, the adjustment processor 21 generates score data D2 by adjusting the start and end points specified by the score data D1 for each note in the same way as in the previous embodiment and also by shortening the duration of a specific note represented by the score data D1 by the shortening rate α. In other words, the score data D2 is generated in which there is reflected a specific note shortened in accordance with the shortening rate α.

The control data generator 23 generates, for each unit period, control data C in accordance with the score data D2. As in the present embodiment, the control data C represents a sounding condition of the target sound corresponding to the score data D2. In the previous embodiment, the shortening rate α is applied to the generation of the control data C. However, in the present embodiment, the shortening rate α is not applied to the generation of the control data C because the shortening rate α is reflected in the score data D2.

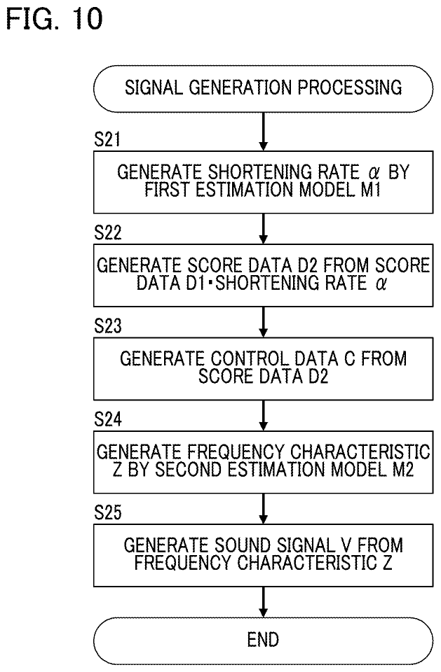

FIG. 10 is a flowchart illustrating example procedures for signal generation processing in the present embodiment. When the signal generation processing is started, the first generator 22 detects one or more specific notes for which staccato is indicated from among a plurality of notes specified by the score data D1, and condition data X related to the respective specific note is input to the first estimation model M1 to generate α shortening rate α (S21).

The adjustment processor 21 generates score data D2 in accordance with the score data D1 and the shortening rate α (S22). In the score data D2, the shortening of specific notes in accordance with the shortening rate α is reflected. The control data generator 23 generates control data C for each unit period in accordance with the score data D2 (S23). As will be understood from the above description, the generation of control data C in the present embodiment includes the process of generating score data D2 in which the duration of a specific note in score data D1 is shortened by a shortening rate α (S22), and the process of generating control data C corresponding to the score data D2 (S23). The score data D2 in the present embodiment is an example of “intermediate data.”

The subsequent steps are the same as those in the previous embodiment. That is, the second generator 241 inputs the control data C to the second estimation model M2 to generate α frequency characteristic Z for each unit period (S24). The waveform synthesizer 242 generates a sound signal V of the target sound of a portion that corresponds to the unit period, from the frequency characteristic Z of that unit period (S25). In the present embodiment, the same effects as those in the previous embodiment are realized.

The shortening rate α, which is used as the ground truth in the learning processing Sc, is set in accordance with a relationship between the sounding period Q of each note in the reference signal R and the sounding period q specified for each note by the score data D2 after adjustment by the adjustment processor 31. On the other hand, the first generator 22 according to the present embodiment calculates a shortening rate α from the initial score data D1 before adjustment. Accordingly, a shortening rate α may be generated that is not completely consistent with the relationship between the condition data X and the shortening rate α learned by the first estimation model M1 in the learning processing Sc, compared with the previous embodiment in which the condition data X based on the adjusted score data D2 is input to the first estimation model M1. Therefore, from a viewpoint of generating a shortening rate α that is exactly consistent with a tendency of the training data T1, the configuration according to the previous embodiment is preferable because in the previous embodiment the shortening rate α is generated by inputting to the first estimation model M1 the condition data X that accords with the adjusted score data D2. However, since a shortening rate α that is generally consistent with a tendency of the training data T1 is also generated in the present embodiment, an error in the shortening rate α is not problematic.

Following are examples of specific modifications that can be made to each of the above embodiments. Two or more aspects freely selected from the following examples may be combined as appropriate to the extent that they do not contradict each other.

(1) In each of the above described embodiments, an amount of reduction relative to the full duration of the specific note before being shortened is given as an example of the shortening rate α. However, the method of calculating the shortening rate α is not limited to the above example. For example, a shortened duration of a specific note after being shortened relative to the full duration of the specific note before being shortened may be used as the shortening rate α, or a numerical value representing the shortened duration of the specific note after being shortened may be used as the shortening rate α. In a case in which the shortened duration of the specific note after being shortened relative to the full duration of the specific note before being shortened is used as the shortening rate α, the shortened duration of the specific note represented by control data C is set to a time length obtained by multiplying the full duration of the specific note before being shortened by the shortening rate α. The shortening rate α may be a number on a real time scale or a number on a time (tick) scale based on a note value of a note.

(2) In each of the above described embodiments, the signal analyzer 32 analyzes the respective sounding periods Q of notes in the reference signal R. However, the method of identifying the sounding period Q is not limited thereto. For example, a user who can refer to a waveform of the reference signal R may manually specify the end point of the sounding period Q.

(3) The sounding condition of a specific note specified by condition data X is not limited to the examples set out in each of the above described embodiments. For example, examples of the condition data X include data representing various conditions for a specific note, such as an intensity (dynamic marks or velocity) of the specific note or notes that come before and after the specific note; a chord, tempo or key signature of a section of a piece of music, the section including the specific note; musical symbols such as slurs related to the specific note; and so on. The amount by which a specific note in a piece of music is shortened also depends on a type of musical instrument used in performance, a performer of a piece of music, or a musical genre of a piece of music. Accordingly, a sounding condition represented by condition data X may include the type of instrument, performer, or musical genre.

(4) In each of the above described embodiments, shortening of notes in accordance with staccato is given as an example, but shortening a duration of a note is not limited to staccato. For example, notes for which accents or the like are indicated also tend to shorten a duration of the note. Therefore, in addition to staccato, accents and other indications are also included under the term, “shortening indication.”

(5) In each of the above described embodiments, an example is given of a configuration in which the output processor 24 includes the second generator 241, which generates frequency characteristics Z using the second estimation model M2. However, the configuration of the output processor 24 is not limited thereto. For example, the output processor 24 may use the second estimation model M2 that learns a relationship between control data C and a sound signal V, to generate α sound signal V in accordance with control data C. The second estimation model M2 outputs respective samples that constitute the sound signal V. The second estimation model M2 may also output probability distribution information (e.g., mean and variance) for samples of the sound signal V. The second generator 241 generates random numbers in accordance with a probability distribution in the form of samples of the sound signal V.

(6) The sound signal generation system 100 may be realized by a server device communicating with a terminal device, such as a portable phone or smartphone. For example, the sound signal generation system 100 generates a sound signal V by signal generation processing of score data D1, which is received from a terminal device, and transmits the processed sound signal V to the terminal device. In a configuration in which score data D2 generated by the adjustment processor 21 of a terminal device is transmitted from the terminal device, the adjustment processor 21 is omitted from the sound signal generation system 100. In a configuration in which the output processor 24 is mounted to the terminal device, the output processor 24 is omitted from the sound signal generation system 100. In this case, control data C generated by the control data generator 23 is transmitted from the sound signal generation system 100 to the terminal device.

(7) In each of the above described embodiments, an example is given of the sound signal generation system 100 having the signal generator 20 and the learning processor 30. However, either the signal generator 20 or the learning processor 30 may be omitted. A computer system with the learning processor 30 can also be described as an estimation model training system (machine learning system). The signal generator 20 may or may not be provided in the estimation model training system.

(8) The functions of the above described sound signal generation system 100 are realized, as described above, by cooperation of one or more processors constituting the controller 11 and the programs (P1, P2) stored in the storage device 12. The programs according to the present disclosure may be provided in a form stored in a computer-readable recording medium and installed on a computer. The recording medium is a non-transitory recording medium, for example, and an optical recording medium (optical disk), such as CD-ROM, is a good example. However, any known types of recording media such as semiconductor recording media or magnetic recording media are also included. Non-transitory recording media include any recording media except for transitory, propagating signals, and volatile recording media are not excluded. In a configuration in which a delivery device delivers a program via a communication network, a storage device 12 that stores the program in the delivery device corresponds to the above non-transitory recording medium.

The program for realizing the first estimation model M1 or the second estimation model M2 is not limited for execution by general-purpose processing circuitry such as a CPU. For example, processing circuitry specialized for artificial intelligence such as a Tensor Processor or Neural Engine may execute the program.

From the above embodiments and modifications, the following configurations are derivable, for example.

The method of generating sound signals according to one aspect (Aspect 1) of the present disclosure is a method of generating a sound signal in accordance with score data representative of respective durations of a plurality of notes and a shortening indication to shorten a duration of a specific note from among the plurality of notes, the method including: generating a shortening rate representative of an amount of shortening of the duration of the specific note, by inputting, to a first estimation model, condition data representative of a sounding condition specified by the score data for the specific note; generating a series of control data, each representing of a control condition corresponding to the score data, the series of control data reflecting a shortened duration of the specific note shortened in accordance with the generated shortening rate; and generating the sound signal in accordance with the series of control data.

According to this aspect, by inputting condition data representative of a sounding condition of a specific note from among a plurality of notes represented by the score data into the first estimation model, a shortening rate representative of an amount by which a duration of the specific note is shortened is generated, and a series of control data, representing a control condition corresponding to the score data, is generated that reflects a shortened duration of the specific note shortened by the shortening rate. In other words, the amount of shortening of the duration of the specific note is changed in accordance with the score data. Therefore, it is possible to generate natural musical sound signals from score data including shortening indications that shorten durations of notes.

A typical example of a “shortening indication” is staccato. However, other indications including accent marks or the like are also included within the term “shortening indication.”

A typical example of the “shortening rate” is the amount of reduction relative to the full duration before shortening, or the amount of the shortened duration after shortening relative to the full duration before shortening, but any value representing an amount of shortening of the duration, such as the value of the shortened duration after shortening, is included in the “shortening rate.”

The “sounding condition” of a specific note represented by the “condition data” is a condition (i.e., a variable factor) that changes an amount by which the duration of the specific note is shortened. For example, a pitch or duration of the specific note is specified by the condition data. Also, for example, various sounding conditions (e.g., pitch, duration, start position, end position, difference in pitch from the specific note, etc.) for at least one of the note before (e.g., just before) and after (e.g., just after) the specific note may also be specified by the condition data. In other words, the sounding conditions represented by the condition data may include not only conditions for the specific note itself, but also conditions for other notes before and after the specific note. Further, the musical genre of a piece of music represented by score data or a performer (including a singer) of a piece of the music may also be included in the sounding condition represented by the condition data.

In the specific example (Aspect 2) of Aspect 1, the first estimation model is a machine learning model that learns a relationship between a sounding condition specified for a specific note in a piece of music and a shortening rate of the specific note. According to the above aspect, a statistically valid shortening rate can be generated for the sounding condition of the specific note in the piece of music under the potential tendencies in the plurality of training data used for training (machine learning).

The type of machine learning model used as the first estimation model may be freely selected. For example, any type of statistical model such as a neural network or a Support Vector Regression (SVR) model can be used as a machine learning model. From a perspective of achieving a highly accurate estimation, neural networks are particularly suitable as machine learning models.

In an example of Aspect 2 (Aspect 3), the sounding condition represented by the condition data includes a pitch and a duration of the specific note and information about at least one of a note before the specific note or a note after the specific note.

In an example (Aspect 4) of any one of Aspect 1 to Aspect 3, the sound signal is generated by inputting the series of control data into a second estimation model separate from the first estimation model. By using a second estimation model prepared separately from the first estimation model to generate sound signals, it is possible to generate natural sounding sound signals.

The “second estimation model” is a machine learning model that learns a relationship between the series of control data and a sound signal. The type of machine learning model used as the second estimation model may be freely selected. For example, any type of statistical model, such as a neural network or SVR model, can be used as a machine learning model.

In an example (Aspect 5) of any one of Aspect 1 to Aspect 4, the generating of the series of control data includes: generating intermediate data in which the duration of the specific note has been shortened by the shortening rate; and generating the series of control data that corresponds to the intermediate data.

In a method for training an estimation model according to one aspect of the present disclosure, a plurality of training data is obtained, each including condition data and a corresponding shortening rate, the condition data representing a sounding condition specified for a specific note by score data representing respective durations of a plurality of notes and a shortening indication for shortening a duration of the specific note, which is one of the plurality of notes, and the shortening rate representing an amount of shortening of the duration of the specific note; and an estimation model is trained by machine learning using the plurality of training data to learn a relationship between the condition data and the shortening rate.

A sound signal generation system according to one aspect of the present disclosure is a system for generating a sound signal depending on score data representative of respective durations of a plurality of notes and a shortening indication to shorten a duration of a specific note from among the plurality of notes, and the system includes: one or more memories for storing instructions; and one or more processors communicatively connected to the one or more memories. The one or more processors execute the instructions to generate α shortening rate representative of an amount of shortening of the duration of the specific note, by inputting, to a first estimation model, condition data representative of a sounding condition specified by the score data for the specific note; generate α series of control data, each representing of a control condition corresponding to the score data, the series of control data reflecting a shortened duration of the specific note shortened in accordance with the generated shortening rate; and generate α sound signal in accordance with the series of control data.

A non-transitory computer-readable storage medium according to one aspect of the present disclosure has stored therein a program executable by a computer to execute a sound signal generation method of generating a sound signal in accordance with score data representative of respective durations of a plurality of notes and a shortening indication to shorten a duration of a specific note from among the plurality of notes, the method including: generating a shortening rate representative of an amount of shortening of the duration of the specific note, by inputting, to a first estimation model, condition data representative of a sounding condition specified by the score data for the specific note; generating a series of control data, each representing a control condition of the sound signal corresponding to the score data, the series of control data reflecting a shortened duration of the specific note shortened in accordance with the generated shortening rate; and generating the sound signal in accordance with the series of control data.

An estimation model according to one aspect of the present disclosure outputs a shortening rate representative of an amount of shortening of a duration of a specific note, in response to input of condition data representative of a sounding condition specified by score data for the specific note. The score data represents respective durations of a plurality of notes and a shortening indication to shorten the duration of the specific note from among the plurality of notes.

### DESCRIPTION OF REFERENCE SIGNS

100 . . . sound signal generation system, 11 . . . controller, 12 . . . storage device, 13 . . . sound outputter, 20 . . . signal generator, 21 . . . adjustment processor, 22 . . . first generator, 23 . . . control data generator, 24 . . . output processor, 241 . . . second 115 generator, 242 . . . waveform synthesizer, 30 . . . learning processor, 31 . . . adjustment processor, 32 . . . signal analyzer, 33 . . . first trainer, 34 . . . control data generator, 35 . . . second trainer

What is claimed:

1. A computer-implemented sound signal generation method of generating a sound signal in accordance with score data representative of respective durations of a plurality of notes and a shortening indication to shorten a duration of a specific note from among the plurality of notes, the method comprising:
generating a shortening rate representative of an amount of shortening of the duration of the specific note, by inputting, to a first estimation model, condition data representative of a sounding condition specified by the score data for the specific note;
generating a series of control data, each representing a control condition of the sound signal corresponding to the score data, the series of control data reflecting a shortened duration of the specific note shortened in accordance with the generated shortening rate; and
generating the sound signal in accordance with the series of control data.

2. The method according to claim 1, wherein the first estimation model is a machine learning model that learns a relationship between a sounding condition specified for a specific note in a piece of music and a shortening rate of the specific note.

3. The method according to claim 2, wherein the sounding condition represented by the condition data includes a pitch and a duration of the specific note and information about at least one of a note before the specific note or a note after the specific note.

4. The method according to claim 1, wherein the sound signal is generated by inputting the series of control data into a second estimation model separate from the first estimation model.

5. The method according to claim 1, wherein the generating of the series of control data includes:
generating intermediate data in which the duration of the specific note has been shortened by the shortening rate; and
generating the series of control data that corresponds to the intermediate data.

6. A computer-implemented estimation model training method comprising:
obtaining a plurality of training data, each including condition data and a corresponding shortening rate, wherein:
the condition data represents a sounding condition specified for a specific note by score data representing: (i) respective durations of a plurality of notes, and (ii) a shortening indication for shortening a duration of the specific note, which is one of the plurality of notes, and
the shortening rate represents an amount of shortening of the duration of the specific note; and
training an estimation model to learn a relationship between the condition data and the shortening rate by machine learning using the plurality of training data.

7. The method according to claim 6, wherein the sounding condition represented by the condition data includes a pitch and a duration of the specific note and information about at least one of a note before the specific note or a note after the specific note.

8. A sound signal generation system for generating a sound signal depending on score data representative of respective durations of a plurality of notes and a shortening indication to shorten a duration of a specific note from among the plurality of notes, the system comprising:
one or more memories for storing instructions; and
one or more processors communicatively connected to the one or more memories and that execute instructions to:
generate α shortening rate representative of an amount of shortening of the duration of the specific note, by inputting, to a first estimation model, condition data representative of a sounding condition specified by the score data for the specific note;
generate α series of control data, each representing a control condition of the sound signal corresponding to the score data, the series of control data reflecting a shortened duration of the specific note shortened in accordance with the generated shortening rate; and
generate the sound signal in accordance with the series of control data.

9. The system according to claim 8, wherein the first estimation model is a machine learning model that learns a relationship between a sounding condition specified for a specific note in a piece of music and a shortening rate of the specific note.

10. The system according to claim 9, wherein the sounding condition represented by the condition data includes a pitch and a duration of the specific note and information about at least one of a note before the specific note or a note after the specific note.

11. The system according to claim 8, wherein the sound signal is generated by inputting the series of control data into a second estimation model separate from the first estimation model.

12. The system according to claim 8, wherein, in the generation of the series of control data, the one or more processors execute the instructions to:
generate intermediate data in which the duration of the specific note has been shortened by the shortening rate; and
generate the series of control data that corresponds to the intermediate data.
